(19) United States
(12) Patent Application Publication
(10) Pub. No.: US 2026/0116475 A1
(43) Pub. Date: Apr. 30, 2026

(54) REAR FLOOR ASSEMBLY FOR VEHICLE

(71) Applicants: Hyundai Motor Company, Seoul (KR); Kia Corporation, Seoul (KR)

(72) Inventors: Jung Ki Kim, Hwaseong-si (KR); Sun Ki Choi, Hwaseong-si (KR); Jung Woo Suh, Hwaseong-si (KR)

(21) Appl. No.: 19/052,925

(22) Filed: Feb. 13, 2025

(30) Foreign Application Priority Data
Oct. 30, 2024 (KR) 10-2024-0151319

(51) Int. Cl. B62D 25/20

(52) U.S. Cl. CPC B62D 25/2027

(57) ABSTRACT

A rear floor assembly for a vehicle can have a structure in which a pair of longitudinal members are connected to a first transverse member and a second transverse member and both the first transverse member and the second transverse member are connected to each other through a connection reinforcement member, so that the overall skeletal structure of the rear floor assembly is capable of being strengthened, side collision performance (crashworthiness) is capable of being increased, and passenger protection performance is capable of being increased.

### CROSS-REFERENCE TO RELATED APPLICATIONS

The present application claims priority to Korean Patent Application No. 10-2024-0151319, filed October 30, 2024, the entire contents of which are incorporated herein for all purposes by this reference.

### TECHNICAL FIELD

The present disclosure relates to a rear floor assembly for a vehicle.

### BACKGROUND

As interest in eco-friendly vehicles increases, the use of an electric vehicle that uses a high voltage battery as a vehicle power source is increasing.

A floor forming the interior of a vehicle may include a front floor and a rear floor, and a high voltage battery may be mounted such that the high voltage battery is positioned on the rear floor.

Therefore, the skeletal structure of the rear floor on which the high voltage battery is mounted is required to be strengthened. Particularly, a structure capable of effectively responding to a side collision is required.

The foregoing is intended merely to aid in the understanding of the background of the present disclosure, and is not intended to mean that the present disclosure falls within the purview of the related art that is already publicly known, available, or in use.

### SUMMARY

The present disclosure relates to a rear floor assembly for a vehicle. More particularly, the present disclosure relates to a rear floor assembly for a vehicle, the rear floor assembly being capable of increasing side collision performance (crashworthiness) by strengthening the skeletal structure thereof.

Accordingly, an embodiment of the present disclosure has been made keeping in mind the above problems occurring in the related art. An embodiment of the present disclosure may provide a rear floor assembly for a vehicle, the rear floor assembly being capable of strengthening the skeletal structure of the rear floor assembly by a connection structure between longitudinal members and transverse members and by inner closed cross-sectional structures of the longitudinal members and the transverse members, thereby being capable of increasing the side collision performance (crashworthiness) and the passenger protection performance.

An embodiment of the present disclosure may provide a rear floor assembly for a vehicle, the rear floor assembly being capable of securing a load pass of a collision energy and applying a connection structure between each load pass so that the collision energy is effectively distributed, thereby being capable of strengthening the skeletal structure of a vehicle body.

According to an embodiment of the present disclosure, a rear floor assembly for a vehicle may include: a rear floor panel; a pair of longitudinal members connected to the rear floor panel and disposed such that the pair of longitudinal members extends in front and rear directions of the vehicle from left and right sides of the vehicle; and a first transverse member and a second transverse member that are connected to the rear floor panel and that are disposed such that the first transverse member and the second transverse member are spaced apart from each other in the front and rear directions of the vehicle, the first transverse member and the second transverse member extending to the left and right sides of the vehicle, wherein opposite ends of each of the first transverse member and the second transverse member are connected to the pair of longitudinal members.

The rear floor assembly may further include: a connection reinforcement member that is disposed between the first transverse member and the second transverse member and that has opposite ends thereof connected to the first transverse member and to the second transverse member, the opposite ends thereof extending in the front and rear directions of the vehicle.

The connection reinforcement member may be provided such that at least two connection reinforcement members are disposed to be spaced apart from each other in the left and right sides of the vehicle.

The first transverse member may be a rear floor front member assembly, and the rear floor front member assembly may include: a rear floor front member having opposite ends thereof connected to the longitudinal members, the opposite ends thereof being disposed in the left and right sides of the vehicle; and a rear floor front member reinforcement member that has opposite ends thereof disposed in the left and right sides of the vehicle and that is disposed below and coupled to the rear floor front member, the rear floor front member reinforcement member having each upper surface of the opposite ends thereof connected to the longitudinal members with each side bracket interposed therebetween, and the rear floor front member reinforcement member having each lower surface of the opposite ends thereof connected to the rear floor panel.

The rear floor front member reinforcement member may protrude frontward from the rear floor front member while an upper surface of the rear floor front member reinforcement member is coupled to a front end portion of the rear floor front member.

When the connection reinforcement member has a structure in which a front end portion of the connection reinforcement member is connected to a rear end portion of the rear floor front member and is separated from and spaced apart from the rear floor front member reinforcement member, a second closed space may be formed between the rear floor front member and the connection reinforcement member and between the rear floor front member reinforcement member and the rear floor panel, and a third closed space may be formed inside the rear floor front member reinforcement member.

A front end portion of the connection reinforcement member may extend frontward and may be connected to a rear end portion of the rear floor front member reinforcement member while the connection reinforcement member is connected to the rear end portion of the rear floor front member.

The rear floor front member reinforcement member may be coupled to a front end portion and a rear end portion of the rear floor front member while the rear floor front member reinforcement member is accommodated in the rear floor front member.

A second closed space may be formed between the rear floor front member and an upper surface of the rear floor front member reinforcement member, a third closed space may be formed inside the rear floor front member reinforcement member, and a fourth closed space may be formed between the connection reinforcement member and the rear floor front member reinforcement member and between the rear floor panel and the second transverse member.

The second transverse member may be a rear floor rear member assembly, and the rear floor rear member assembly may include: a rear floor rear member upper having opposite ends thereof connected to the longitudinal members, the opposite ends thereof being disposed in the left and right sides of the vehicle; and a rear floor rear member lower that is connected to the rear floor rear member upper so that a fifth closed space is formed between the rear floor rear member upper and the rear floor rear member lower and that has opposite ends thereof connected to the longitudinal members, the opposite ends thereof being disposed in the left and right sides of the vehicle.

The rear floor assembly may further include a rear floor rear member reinforcement member disposed in the fifth closed space and coupled to the rear floor rear member upper and to the rear floor rear member lower.

A sixth closed space may be formed inside the rear floor rear member reinforcement member.

Each of the longitudinal members, the first transverse member, and the second transverse member may be provided with each cross-sectional structure in which each inner portion thereof is closed so that a collision energy that is generated when a side collision occurs is distributed.

As described above, the rear floor assembly for the vehicle according to the present disclosure may have the structure in which the pair of longitudinal members is connected to the first transverse member and the second transverse member and both the first transverse member and the second transverse member are connected to each other through the connection reinforcement member, so that the overall skeletal structure of the rear floor assembly is capable of being strengthened. Accordingly, an embodiment may have advantages that the side collision performance (crashworthiness) is capable of being increased and the passenger protection performance is capable of being increased.

Because the rear floor assembly according to an embodiment of the present disclosure may be configured such that the first load pass, the second load pass, and the third load pass that distribute the collision energy through the connection of the longitudinal members, the first transverse member, the second transverse member, and the connection reinforcement member may be formed, there may be advantages that the side collision performance may be capable of being increased and the passenger protection performance may be capable of being increased.

In the rear floor assembly according to an embodiment of the present disclosure, the longitudinal members, the first transverse member, and the second transverse member may have closed cross-sectional structures therein, so that there may be an advantage that the collision energy generated when a side collision occurs may be capable of being effectively absorbed and distributed.

The advantages that can be obtained from an embodiment of the present disclosure are not necessarily limited to the above-mentioned advantages, and other advantages not mentioned herein can be understood by those skilled in the art from the following description.

### BRIEF DESCRIPTION OF THE DRAWINGS

The above and other features and advantages of an embodiment of the present disclosure can be more clearly understood from the following detailed description when taken in conjunction with the accompanying drawings, in which:

FIG. 1 is a perspective view illustrating a rear floor assembly according to an embodiment of the present disclosure;

FIG. 2 is an exploded view illustrating the rear floor assembly according to an embodiment of the present disclosure;

FIGS. 3 to 5 are cross-sectional views respectively taken along the I-I line, the II-II line, and the III-III line in FIG. 1, respectively;

FIGS. 6 and 7 are views illustrating other embodiments of the present disclosure contrasting to an embodiment illustrated in FIG. 5; and

FIG. 8 is a view illustrating an example in which a mounting part of a high voltage battery is positioned in the rear floor assembly according to an embodiment of the present disclosure.

### DETAILED DESCRIPTION OF ILLUSTRATIVE EMBODIMENTS

Detailed description of known technologies can be omitted if it is determined that the detailed description of the known technologies can obscure the example embodiments of the present specification. The accompanying drawings can be merely intended to easily describe the example embodiments of the present specification, but the spirit and technical scopes of the present specification are not necessarily limited by the accompanying drawings. It can be understood that the present specification is not limited to specific disclosed example embodiments, but can include modifications, equivalents, and substitutes included within the spirit and technical scopes of the present disclosure.

Terms including ordinals such as “first” or “second” used herein may be used to describe various elements, but the elements are not necessarily limited by such terms. Such terms can be used merely for the purpose of distinguishing one constituent element from another constituent element.

As used herein, singular forms can be intended to include plural forms as well, unless the context clearly indicates otherwise.

It can be understood that terms such as “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

When a component is described as being “connected”, “coupled”, or “linked” to another component, that component may be directly connected, coupled, or linked to that other component. However, it can be understood that yet another component between each of the components may be present. In contrast, it can be understood that when a component is referred to as being “directly coupled” or “directly connected” to another component, there are no intervening components present.

“Unit” or “control unit” included in the names of the motor control unit (MCU) and the hybrid control unit (HCU) can generally refer to a controller that controls a specific function of the vehicle and does not mean a generic function unit.

“Controller” may include a communication device configured to communicate with another controller or a sensor to control a function assigned thereto, a memory configured to store an operating system, logic commands, and input and output information, and at least one processor configured to perform determination, calculation, and decision necessary to control the assigned function.

Hereinafter, example embodiments disclosed in the present specification will be described in detail with reference to the accompanying drawings. In the present specification, same or similar components can be denoted by same or similar reference numerals, and a repeated description thereof can be omitted.

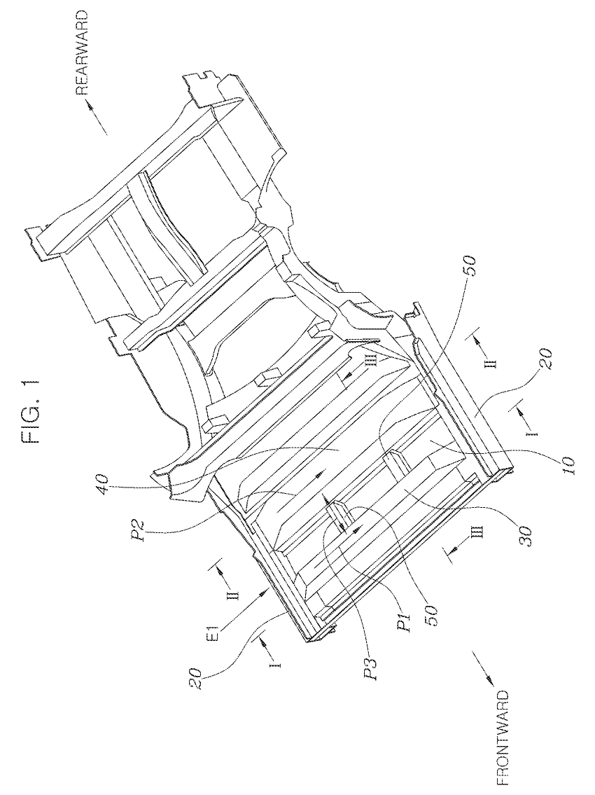

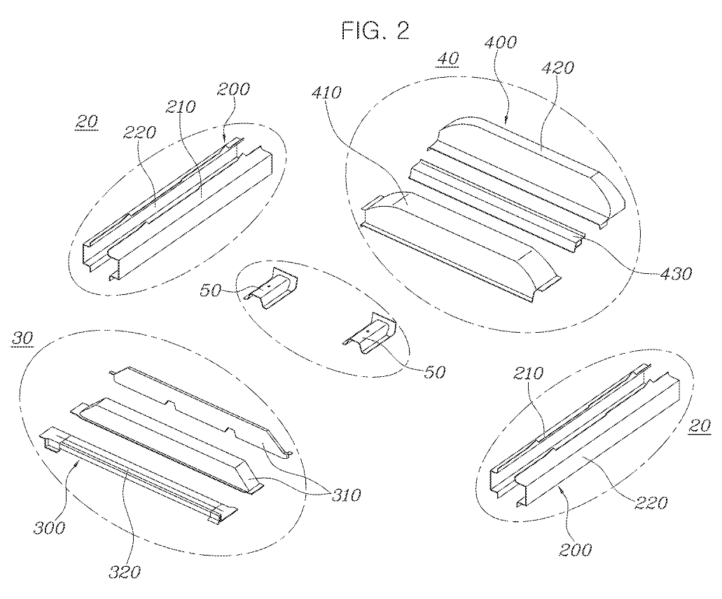

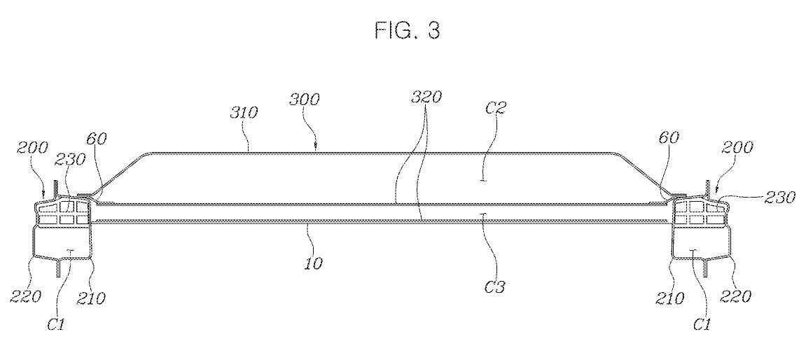

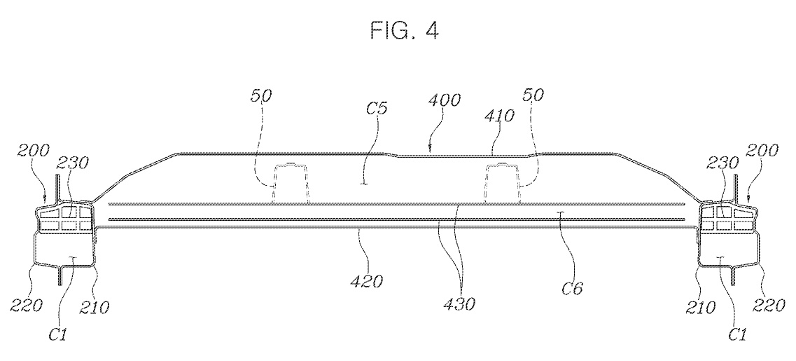

As illustrated in FIG. 1 to FIG. 8, a rear floor assembly for a vehicle according to an embodiment of the present disclosure may include: a rear floor panel 10; a pair of longitudinal members 20 connected to the rear floor panel 10 and disposed such that the pair of longitudinal members 20 extends in front and rear directions of a vehicle on left and right sides of the vehicle; a first transverse member 30 and a second transverse member 40 that are connected to the rear floor panel 10 and are disposed such that the first transverse member 30 and the second transverse member 40 are spaced apart from each other in the front and rear directions of the vehicle, the first transverse member 30 and the second transverse member 40 extending to the left and right sides of the vehicle; and a connection reinforcement member 50 that is disposed between the first transverse member 30 and the second transverse member 40 and that has opposite ends thereof connected to the first transverse member 30 and the second transverse member 40, respectively, the opposite ends extending to the front and rear directions of the vehicle. Opposite ends of each of the first transverse member 30 and the second transverse member 40 may be connected to the pair of longitudinal members 20, respectively.

The rear floor assembly according to an embodiment of the present disclosure may have a structure in which the pair of longitudinal members 20 are connected to the first transverse member 30 and the second transverse member 40 and both the first transverse member 30 and the second transverse member 40 are connected to each other through the connection reinforcement member 50, so that there are advantages that the skeletal structure of the rear floor assembly may be capable of being strengthened, side collision performance (crashworthiness) may be capable of being increased, and passenger protection performance may be capable of being increased.

In the rear floor assembly according to an embodiment of the present disclosure, a connection structure between the longitudinal members 20 and both the first transverse member 30 and the second transverse member 40 may form a first load pass P1 and a second load pass P2 distributing a collision energy E1 that may be generated when a side collision accident occurs into two paths. The connection reinforcement member 50 may form a third load pass P3 distributing a collision energy into the first transverse member 30 and the second transverse member 40.

The first load pass P1, the second load pass P2, and the third load pass P3 may serve to effectively distribute the collision energy E1 that may be generated when a side collision accident occurs to various parts of the rear floor assembly, so that there may be an advantage that the side collision performance and the passenger protection performance may be capable of being increased.

At least two connection reinforcement members 50 may be disposed to be spaced apart from each other in the left and right sides of the vehicle, and at least two connection reinforcement members 50 may strengthen the skeletal structure and the side collision performance of the rear floor assembly.

Each of the longitudinal members 20, the first transverse member 30, and the second transverse member 40 may be provided with each cross-sectional structure in which each inner portion thereof is closed so that the collision energy E1 that may be generated when a side collision occurs may be effectively distributed.

The longitudinal member 20 according to an embodiment of the present disclosure may be a side sill assembly 200.

The side sill assembly 200 may include: a side sill inner 210 connected to one of the opposite ends of the first transverse member 30 and to one of the opposite ends of the second transverse member 40; and a side sill outer 220 forming a first closed space C1 inside the side sill assembly 200 by being connected to the side sill inner 210.

By the first closed space C1, the skeletal structure of the side sill assembly 200 may be strengthened, and the collision energy E1 that may be generated when a side collision occurs may be more effectively absorbed and distributed.

In an embodiment of the present disclosure, a side sill reinforcement member 230 that may be disposed in the first closed space C1 and that may be coupled to the side sill inner 210 and to the side sill outer 220 may further be included, and the side sill reinforcement member 230 may be formed in a honeycomb structure.

The side sill reinforcement member 230 having the honeycomb structure may serve to further strengthen the structure of the side sill assembly 200, thereby being capable of strengthening the skeletal structure of the side sill assembly 200.

The first transverse member 30 may be a rear floor front member assembly 300.

The rear floor front member assembly 300 may include: a rear floor front member 310 having opposite ends connected to the longitudinal members 20, the opposite ends thereof being disposed in the left and right sides of the vehicle; and a rear floor front member reinforcement member 320 that may have opposite ends thereof disposed in the left and right sides of the vehicle and that may be disposed below and coupled to the rear floor front member 310, the rear floor front member reinforcement member 320 may have each upper surface of the opposite ends thereof connected to the longitudinal members 20 with each side bracket 60 interposed therebetween, and the rear floor front member reinforcement member 320 may have each lower surface of the opposite ends thereof connected to the rear floor panel 10.

The opposite ends of the rear floor front member 310 may be coupled to and connected to the side sill inners 210 that may constitute the longitudinal members 20.

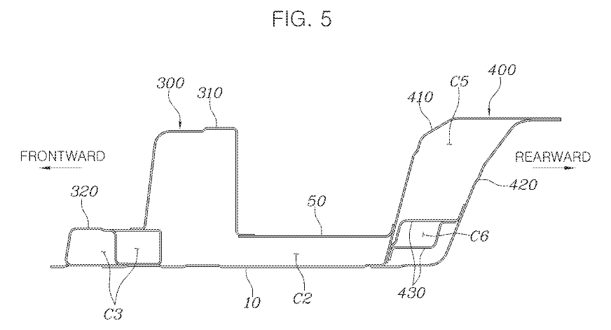

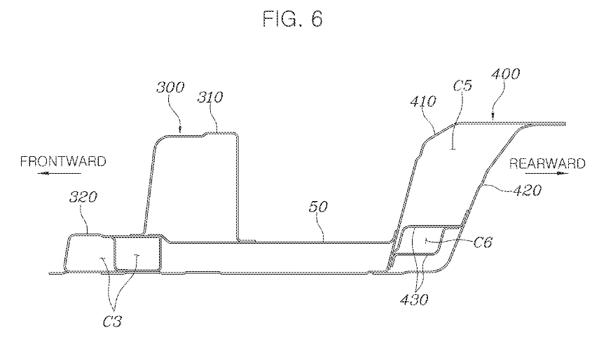

Referring to FIG. 5 and FIG. 6, the rear floor front member reinforcement member 320 may have a structure in which the rear floor front member reinforcement member 320 protrudes frontward from the rear floor front member 310 while the upper surface of the rear floor front member reinforcement member 320 may be coupled to a front end portion of the rear floor front member 310, and such a structure may have an advantage that the skeletal structure at a front side of the rear floor front member 310 may be capable of being further strengthened.

As illustrated in FIG. 5, when the rear floor front member reinforcement member 320 has the structure in which the rear floor front member reinforcement member 320 protrudes frontward from the rear floor front member 310 while the upper surface of the rear floor front member reinforcement member 320 is coupled to the front end portion of the rear floor front member 310 and the connection reinforcement member 50 may have a structure in which a front end portion of the connection reinforcement member 50 is connected to a rear end portion of the rear floor front member 310 and may be separated from and spaced apart from the rear floor front member reinforcement member 320, a second closed space C2 may be formed between the rear floor front member 310 and the connection reinforcement member 50 and between the rear floor front member reinforcement member 320 and the rear floor panel 10, and a third closed space C3 may be formed inside the rear floor front member reinforcement member 320.

By the second closed space C2 and the third closed space C3, the skeletal structure of the rear floor front member assembly 300 may be strengthened, and the collision energy E1 that may be generated when a side collision occurs may be more effectively absorbed and distributed.

Referring to FIG. 6, when the rear floor front member reinforcement member 320 has the structure in which the rear floor front member reinforcement member 320 protrudes frontward from the rear floor front member 310 while the upper surface of the rear floor front member reinforcement member 320 is coupled to the front end portion of the rear floor front member 310, the connection reinforcement member 50 may have a structure in which the front end portion of the connection reinforcement member 50 extends frontward and is connected to a rear end portion of the rear floor front member reinforcement member 320 while the connection reinforcement member 50 is connected to the rear end portion of the rear floor front member 310.

Such a structure may realize a connection between the connection reinforcement member 50 and the rear floor front member reinforcement member 320, and there may be an advantage that the skeletal structure of the rear floor assembly may be capable of being further strengthened.

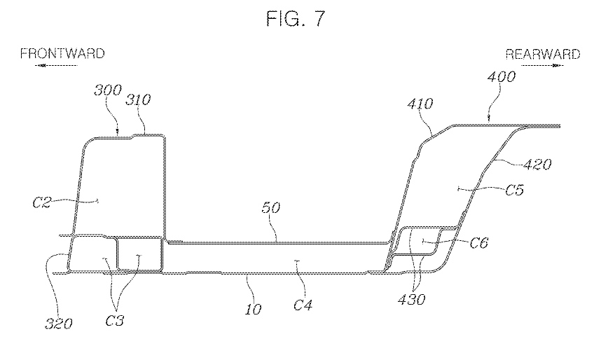

Referring to FIG. 7, the rear floor front member reinforcement member 320 may have a structure in which the rear floor front member reinforcement member 320 is coupled to the front end portion and the rear end portion of the rear floor front member 310 while the rear floor front member reinforcement member 320 is accommodated in the rear floor front member 310, and such a structure may have an advantage that the skeletal structure of the rear floor front member 310 may be capable of being further strengthened.

As illustrated in FIG. 7, when the rear floor front member reinforcement member 320 has the structure in which the rear floor front member reinforcement member 320 is coupled to the rear floor front member 310 while the rear floor front member reinforcement member 320 is accommodated in the rear floor front member 310, the second closed space C2 may be formed between the rear floor front member 310 and the upper surface of the rear floor front member reinforcement member 320, the third closed space C3 may be formed inside the rear floor front member reinforcement member 320, and a fourth closed space C4 may be formed between the connection reinforcement member 50 and the rear floor front member reinforcement member 320 and between the rear floor panel 10 and the second transverse member 40.

By the second closed space C2, the third closed space C3, and the fourth closed space C4, each skeletal structure of the rear floor front member assembly 300, the connection reinforcement member 50, and the rear floor panel 10 may be capable of being strengthened, and the collision energy E1 that may be generated when a side collision occurs may be more effectively absorbed and distributed.

The second transverse member 40 may be a rear floor rear member assembly 400.

The rear floor rear member assembly 400 may include: a rear floor rear member upper 410 that may have opposite ends thereof connected to the longitudinal members 20, wherein the opposite ends thereof may be disposed in the left and right sides of the vehicle; a rear floor rear member lower 420 that may be connected to the rear floor rear member upper 410 so that a fifth closed space C5 may be formed between the rear floor rear member upper 410 and the rear floor rear member lower 420 and that may have opposite ends thereof connected to the longitudinal members 20, wherein the opposite ends thereof may be disposed in the left and right sides of the vehicle; and a rear floor rear member reinforcement member 430 may be disposed in the fifth closed space C5 and coupled to the rear floor rear member upper 410 and to the rear floor rear member lower 420.

A sixth closed space C6 may be formed inside the rear floor rear member reinforcement member 430.

The opposite ends of the rear floor rear member upper 410 and the opposite ends of the rear floor rear member lower 420 may be coupled to and connected to the side sill inners 210 that constitute the longitudinal members 20.

By the fifth closed space C5 and the sixth closed space C6, the skeletal structure of the rear floor rear member assembly 400 may be strengthened, and the collision energy E1 that may be generated when a side collision occurs may be more effectively absorbed and distributed.

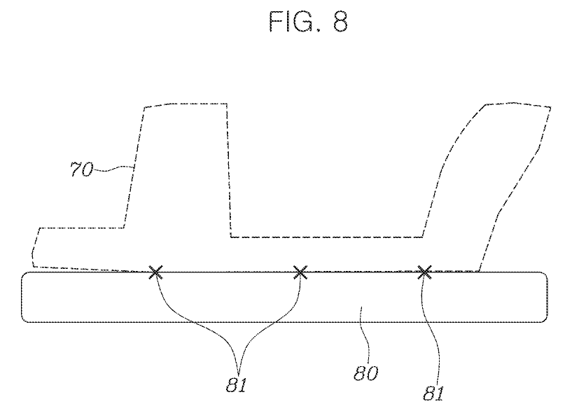

Referring to FIG. 8, a mounting part 81 of a high voltage battery 80 may be positioned below a closed cross-sectional structure 70 that is formed by coupling between the rear floor panel 10 and the pair of longitudinal members 20 and between the first transverse member 30 and the second transverse member 40.

As the mounting part 81 of the high voltage battery 80 corresponding to a mass body may be positioned in the closed cross-sectional structure 70 of the rear floor assembly according to an embodiment of the present disclosure, there may be an advantage that a coupling strength of the mounting part 81 of the high voltage battery 80 may be capable of being maintained more robustly.

As described above, the rear floor assembly for the vehicle according to an embodiment of the present disclosure may have the structure in which the pair of longitudinal members 20 are connected to the first transverse member 30 and the second transverse member 40 and both the first transverse member 30 and the second transverse member 40 can be connected to each other through the connection reinforcement member 50, so that the overall skeletal structure of the rear floor assembly can be capable of being strengthened. Accordingly, there can be advantages that the side collision performance (crashworthiness) can be capable of being increased and the passenger protection performance can be capable of being increased.

Because the rear floor assembly according to an embodiment of the present disclosure may be configured such that the first load pass P1, the second load pass P2, and the third load pass P3 that distribute the collision energy E1 through the connection of the longitudinal members 20, the first transverse member 30, the second transverse member 40, and the connection reinforcement member 50 may be formed, there may be advantages that the side collision performance may be capable of being increased and the passenger protection performance may be capable of being increased.

In the rear floor assembly according to an embodiment of the present disclosure, the longitudinal members 20, the first transverse member 30, and the second transverse member 40 may have closed cross-sectional structures therein, so that there may be an advantage that the collision energy E1 that may be generated when a side collision occurs may be capable of being effectively absorbed and distributed.

Although example embodiments of the present disclosure have been described herein, it may be understood that the present disclosure should not be necessarily limited to these example embodiments and that various changes and modifications can be made by one ordinary skilled in the art within the spirit and scopes of the present disclosure.

What is claimed is:

1. A rear floor assembly for a vehicle, comprising:
a rear floor panel;
a pair of longitudinal members connected to the rear floor panel and disposed such that the pair of longitudinal members extend in front and rear directions of the vehicle on left and right sides of the vehicle; and
a first transverse member and a second transverse member connected to the rear floor panel and disposed such that the first transverse member and the second transverse member are spaced apart from each other in the front and rear directions of the vehicle, and such that the first transverse member and the second transverse member extend to the left and right sides of the vehicle, wherein opposite ends of each of the first transverse member and the second transverse member are connected to the pair of longitudinal members, respectively.

2. The rear floor assembly of claim 1, further comprising a connection reinforcement member disposed between the first transverse member and the second transverse member, wherein the connection reinforcement member has opposite ends thereof connected to the first transverse member and to the second transverse member, respectively, and the opposite ends thereof extend in the front and rear directions of the vehicle.

3. The rear floor assembly of claim 2, wherein the connection reinforcement member is configured such that at least two connection reinforcement members are disposed to be spaced apart from each other in the left and right sides of the vehicle.

4. The rear floor assembly of claim 2, wherein the first transverse member includes a rear floor front member assembly, wherein the rear floor front member assembly comprises:
a rear floor front member having opposite ends thereof connected to the longitudinal members, respectively, wherein the opposite ends thereof are disposed in the left and right sides of the vehicle; and
a rear floor front member reinforcement member having opposite ends thereof disposed in the left and right sides of the vehicle, wherein the rear floor front member reinforcement member is disposed below and coupled to the rear floor front member, wherein the rear floor front member reinforcement member has each upper surface of the opposite ends thereof connected to the longitudinal members, respectively, with each side bracket interposed therebetween, and wherein the rear floor front member reinforcement member has each lower surface of the opposite ends thereof connected to the rear floor panel.

5. The rear floor assembly of claim 4, wherein the rear floor front member reinforcement member protrudes frontward from the rear floor front member and an upper surface of the rear floor front member reinforcement member is coupled to a front end portion of the rear floor front member.

6. The rear floor assembly of claim 5, wherein, with the connection reinforcement member having a front end portion of the connection reinforcement member connected to a rear end portion of the rear floor front member and separated from and spaced apart from the rear floor front member reinforcement member, a second closed space is bounded between the rear floor front member and the connection reinforcement member and between the rear floor front member reinforcement member and the rear floor panel, and a third closed space is bounded inside the rear floor front member reinforcement member.

7. The rear floor assembly of claim 5, wherein, a front end portion of the connection reinforcement member extends frontward and is connected to a rear end portion of the rear floor front member reinforcement member and the connection reinforcement member is connected to the rear end portion of the rear floor front member.

8. The rear floor assembly of claim 4, wherein the rear floor front member reinforcement member is coupled to a front end portion and a rear end portion of the rear floor front member and the rear floor front member reinforcement member is accommodated in the rear floor front member.

9. The rear floor assembly of claim 8, wherein a second closed space is bounded between the rear floor front member and the upper surface of the rear floor front member reinforcement member,
wherein a third closed space is bounded inside the rear floor front member reinforcement member, and
wherein a fourth closed space is bounded between the connection reinforcement member and the rear floor front member reinforcement member and between the rear floor panel and the second transverse member.

10. The rear floor assembly of claim 1, wherein the second transverse member includes a rear floor rear member assembly, wherein the rear floor rear member assembly comprises:
a rear floor rear member upper having opposite ends thereof connected to the longitudinal members, respectively, wherein the opposite ends thereof are disposed in the left and right sides of the vehicle; and
a rear floor rear member lower connected to the rear floor rear member upper so that a fifth closed space is bounded between the rear floor rear member upper and the rear floor rear member lower, wherein the rear floor rear member lower has opposite ends thereof connected to the longitudinal members, respectively, and wherein the opposite ends thereof are disposed in the left and right sides of the vehicle.

11. The rear floor assembly of claim 10, further comprising a rear floor rear member reinforcement member disposed in the fifth closed space and coupled to the rear floor rear member upper and to the rear floor rear member lower.

12. The rear floor assembly of claim 11, wherein a sixth closed space is bounded inside the rear floor rear member reinforcement member.

13. The rear floor assembly of claim 1, wherein each of the longitudinal members, the first transverse member, and the second transverse member has a cross-sectional structure in which each inner portion thereof defines a closed structure configured so that a collision energy generated by a side collision is distributed among the longitudinal members, the first transverse member, and the second transverse member.

14. A rear floor assembly for a vehicle, comprising:
a rear floor panel;
a left longitudinal member and a right longitudinal member connected to the rear floor panel and disposed such that the left longitudinal member extends in front and rear directions of the vehicle on a left side of the vehicle and such that the right longitudinal member extends in the front and rear directions of the vehicle on a right side of the vehicle;
a first transverse member connected to the rear floor panel and disposed such that the first transverse member extends to the left and right sides of the vehicle, wherein first-transverse-member opposite ends of the first transverse member are connected to the left and right longitudinal members, respectively;
a second transverse member connected to the rear floor panel and disposed such that the second transverse member extends to the left and right sides of the vehicle, wherein second-transverse-member opposite ends of the second transverse member are connected to the left and right longitudinal members, respectively, and wherein the first transverse member and the second transverse member are spaced apart from each other in the front and rear directions of the vehicle;
a left connection reinforcement member disposed between the first transverse member and the second transverse member on the left side of the vehicle, wherein the left connection reinforcement member has left-connection-reinforcement-member opposite ends thereof connected to the first transverse member and to the second transverse member, respectively, and wherein the left connection reinforcement member extends in the front and rear directions of the vehicle; and
a right connection reinforcement member disposed between the first transverse member and the second transverse member on the right side of the vehicle, wherein the right connection reinforcement member has right-connection-reinforcement-member opposite ends thereof connected to the first transverse member and to the second transverse member, respectively, and wherein the right connection reinforcement member extends in the front and rear directions of the vehicle, wherein the right connection reinforcement member and the left connection reinforcement member are disposed to be spaced apart from each other.

15. The rear floor assembly of claim 14, wherein the first transverse member includes a rear floor front member assembly, wherein the rear floor front member assembly comprises:
a rear floor front member having rear-floor-front-member opposite ends thereof connected to the left and right longitudinal members, respectively, wherein the rear floor front member extends to the left and right sides of the vehicle; and
a rear floor front member reinforcement member having rear-floor-front-member-reinforcement-member opposite ends thereof disposed in the left and right sides of the vehicle, wherein the rear floor front member reinforcement member is disposed below and coupled to the rear floor front member, wherein the rear floor front member reinforcement member has each upper surface of the rear-floor-front-member-reinforcement-member opposite ends connected to the longitudinal members, respectively, with each having a side bracket interposed therebetween, and wherein the rear floor front member reinforcement member has each lower surface of the rear-floor-front-member-reinforcement-member opposite ends connected to the rear floor panel.

16. The rear floor assembly of claim 15, wherein the rear floor front member reinforcement member protrudes frontward from the rear floor front member, and wherein a rear-floor-front-member-reinforcement-member upper surface of the rear floor front member reinforcement member is coupled to a rear-floor-front-member frontend portion of the rear floor front member.

17. The rear floor assembly of claim 16, wherein, with each of the left and right connection reinforcement members having a connection-reinforcement-member frontend portion connected to a rear-floor-front-member rear end portion of the rear floor front member and separated from and spaced apart from the rear floor front member reinforcement member, a first closed space is bounded between the rear floor front member and each of the left and right connection reinforcement members and between the rear floor front member reinforcement member and the rear floor panel, and a second closed space is bounded inside the rear floor front member reinforcement member.

18. The rear floor assembly of claim 16, wherein a connection-reinforcement-member frontend portion of each of the left and right connection reinforcement members extends frontward and is connected to a rear-floor-front-member-reinforcement-member rear end portion of the rear floor front member reinforcement member, and wherein each of the left and right connection reinforcement members is connected to a rear-floor-front-member rear end portion of the rear floor front member.

19. The rear floor assembly of claim 15, wherein the rear floor front member reinforcement member is coupled to a rear-floor-front-member frontend portion and a rear-floor-front-member rear end portion of the rear floor front member, and wherein the rear floor front member reinforcement member is accommodated in the rear floor front member.

20. A rear floor assembly for a vehicle, comprising:
a rear floor panel;
a left longitudinal member and a right longitudinal member connected to the rear floor panel and disposed such that the left longitudinal member extends in front and rear directions of the vehicle on a left side of the vehicle and such that the right longitudinal member extends in the front and rear directions of the vehicle on a right side of the vehicle;
a first transverse member connected to the rear floor panel and disposed such that the first transverse member extends to the left and right sides of the vehicle, wherein first-transverse-member opposite ends of the first transverse member are connected to the left and right longitudinal members, respectively;
a second transverse member connected to the rear floor panel and disposed such that the second transverse member extends to the left and right sides of the vehicle, wherein second-transverse-member opposite ends of the second transverse member are connected to the left and right longitudinal members, respectively, and wherein the first transverse member and the second transverse member are spaced apart from each other in the front and rear directions of the vehicle;
a left connection reinforcement member disposed between the first transverse member and the second transverse member on the left side of the vehicle, wherein the left connection reinforcement member has left-connection-reinforcement-member opposite ends thereof connected to the first transverse member and to the second transverse member, respectively, and wherein the left connection reinforcement member extends in the front and rear directions of the vehicle;
a right connection reinforcement member disposed between the first transverse member and the second transverse member on the right side of the vehicle, wherein the right connection reinforcement member has right-connection-reinforcement-member opposite ends thereof connected to the first transverse member and to the second transverse member, respectively, wherein the right connection reinforcement member extends in the front and rear directions of the vehicle, and wherein the right connection reinforcement member and the left connection reinforcement member are disposed to be spaced apart from each other,
wherein the first transverse member includes a rear floor front member assembly, wherein the rear floor front member assembly comprises:
a rear floor front member having rear-floor-front-member opposite ends thereof connected to the left and right longitudinal members, respectively, wherein the rear floor front member extends to the left and right sides of the vehicle, and
a rear floor front member reinforcement member having rear-floor-front-member-reinforcement-member opposite ends thereof disposed in the left and right sides of the vehicle, wherein the rear floor front member reinforcement member is disposed below and coupled to the rear floor front member, wherein the rear floor front member reinforcement member has each upper surface of the rear-floor-front-member-reinforcement-member opposite ends connected to the left and right longitudinal members, respectively, with each having a side bracket interposed therebetween, and wherein the rear floor front member reinforcement member has each lower surface of the rear-floor-front-member-reinforcement-member opposite ends connected to the rear floor panel, wherein the rear floor front member reinforcement member protrudes frontward from the rear floor front member, and wherein a rear-floor-front-member-reinforcement-member upper surface of the rear floor front member reinforcement member is coupled to a rear-floor-front-member frontend portion of the rear floor front member,
wherein the second transverse member includes a rear floor rear member assembly, wherein the rear floor rear member assembly comprises:
a rear floor rear member upper having rear-floor-rear-member-upper opposite ends thereof connected to the left and right longitudinal members, respectively, wherein the rear-floor-rear-member-upper opposite ends thereof are disposed in the left and right sides of the vehicle; and
a rear floor rear member lower connected to the rear floor rear member upper so that a first closed space is bounded between the rear floor rear member upper and the rear floor rear member lower, wherein the rear floor rear member lower has rear-floor-rear-member-lower opposite ends thereof connected to the left and right longitudinal members, respectively, and wherein the rear-floor-rear-member-lower opposite ends thereof are disposed in the left and right sides of the vehicle; and
a rear floor rear member reinforcement member disposed in the first closed space and coupled to the rear floor rear member upper and to the rear floor rear member lower, wherein a second closed space is bounded inside the rear floor rear member reinforcement member.
